(19) United States
(12) Patent Application Publication
(10) Pub. No.: US 2015/0277705 A1
(43) Pub. Date: Oct. 1, 2015

(54) GRAPHICAL USER INTERFACE USER INPUT TECHNIQUE FOR CHOOSING AND COMBINING DIGITAL IMAGES AS VIDEO

(71) Applicant: YouLapse Oy, Helsinki (FI)

(72) Inventors: Antti AUTIONIEMI, Helsinki (FI); Nico HAMALAINEN, Helsinki (FI)

(73) Assignee: YouLapse Oy, Helsinki (FI)

(21) Appl. No.: 14/224,354

(22) Filed: Mar. 25, 2014

(51) Int. Cl. G06F 3/0484; G06F 3/0488

(52) U.S. Cl. CPC G06F 3/04842; G06F 3/0488

(57) ABSTRACT

Electronic device comprising: a display screen, a computing entity configured to display graphical user interface via the display screen, and configured to capture user input via said graphical user interface, the computing entity further being configured to present a plurality of graphical indications of selectable image entities via the graphical user interface; detect an essentially continuous user input gesture via said graphical user interface along a path substantially upon two or more of said indications as a selection of such indications and corresponding two or more image entities; translate the selected image entities into an action producing a video representation of said image entities. A corresponding method is presented.

### FIELD OF THE INVENTION

Generally the present invention concerns giving user input on an electronic user interface. Particularly, however not exclusively, the invention pertains to a method for using a particular gesture for controlling a graphical user interface (GUI).

### BACKGROUND

The popularity of taking photos with mobile device cameras such as those of smartphones and tablets, has led to a huge increase in the need for storing images. Accordingly, especially due to the related increase in available storage space in mobile terminals, which is in turn enabled by the rapidly developing memory technology, the management and utilization of the storage and images stored thereat efficiently has become increasingly difficult.

For example, scrolling through and selecting pictures from a massive offering of unsorted photos with different dates, locations and even devices is arduous and inefficient. For many, this in turn leads to situations wherein many of the pictures are left unutilized and basically forgotten in storage folders.

Even further, navigating inside a folder is only half of the hassle of finding the desired photos. It is very common for graphical user interface features to represent photos only according to their file names or as illustrative miniature-sized versions or icons representing the photo content. This makes it very cumbersome for a user to go through many photos because the user has to check the metadata such as time and location data for each photo individually.

Finally, selecting a plurality of photos from a folder is usually equally difficult. The user has to either mark each photo individually, outline a nonexclusive square-like area of photos, or even worse, select each photo from a list without even seeing the representation, not to mention the time and location data, of the photos.

### SUMMARY OF THE INVENTION

The objective of the embodiments of the present invention is to at least alleviate one or more of the aforesaid drawbacks evident in the prior art arrangements particularly in the context of electronic graphical user interface arrangements and input methods that allow for continuous user input for choosing graphical user interface features. The objective is generally achieved with a device and input method in accordance with the present invention by having a graphical user interface on a device to be arranged to receive and identify a path according to a continuous gesture upon a plurality of GUI features via said device's user interface.

One of the advantageous features of the present invention is that it allows for choosing graphical user interface image entities, such as picture, photograph and other image files with freely movable continuous gesture.

In accordance with one aspect of the present invention an electronic device comprising:
a display screen,
a computing entity configured to display graphical user interface via the display screen, and configured to capture user input via said graphical user interface, the computing entity further being configured to:
present a plurality of graphical indications of selectable image entities via the graphical user interface;
detect an essentially continuous user input gesture via said graphical user interface along a path substantially upon two or more of said indications as a selection of such indications and corresponding two or more image entities;
translate the selected image entities into an action producing a video representation of said image entities.

According to an exemplary embodiment of the present invention the computing entity preferably arranges the graphical indications as navigable by e.g. scrolling and/or panning during the engendering of user input gesture; i.e., the selection of image entities.

According to an exemplary embodiment of the invention the path essentially defined by the user input gesture may be graphically and/or textually visualized during the engendering of the user input gesture and/or essentially after a user input gesture has been engendered. The graphical and/or textual visualization may comprise tagging, highlighting, outlining, coloring, text or a number of letters along the path, numbers along the path, alphanumeric markings along the path, and/or the graphical indications, e.g. curves or lines, and/or other marking of the path.

According to an exemplary embodiment of the present invention the computing entity may be configured to inquire a confirmation from a user to commence the process of translating selected image entities into an action producing a video representation of said image entities. Said inquiry to commence the translation of selected image entities into an action producing a video representation of said image entities may be done after the user input gesture has stopped, after the user input gesture has remained substantially static for a period of time, and/or after the user input gesture engendering via the graphical user interface has stopped, such as when the user input gesture is no longer detected via the graphical user interface. According to an exemplary embodiment of the present invention the computing entity may be configured to commence the process of translating selected image entities into an action producing a video representation of said image entities substantially automatically optionally directly after the computing entity has detected a selection of image entities.

According to an exemplary embodiment of the present invention the inquiry to commence the process of translating selected image entities into an action producing a video representation of said image entities may be graphical, such as a tagging, highlighting, outlining, coloring, and/or other marking of the selection. According to an exemplary embodiment of the present invention the inquiry to commence the process of translating selected image entities into an action producing a video representation of said image entities may be essentially textual, such as a question posed via the graphical user interface to the user. Optionally the inquiry may be done via another view than the one that is present during the selection of image entities.

According to an exemplary embodiment of the present invention the computing entity may be configured to allow adding or removing a number of image entities after a selection of image entities has been detected. According to an exemplary embodiment the image entities may be added and/or removed from a selection of image entities by engendering a user input gesture upon a number of graphical indications and/or by essentially pointing a number of (individual) graphical indications. Optionally the computing entity is configured to deselect a selected image entity when a user input upon the already selected graphical indication of the image entity is detected.

According to an exemplary embodiment of the present invention the video representation of the images may comprise a representation of the selected image entities arranged essentially sequentially chronologically, for example according to time code, time stamp and/or other time data, optionally comprised in the image entities as metadata.

According to an exemplary embodiment of the present invention the framerate, the frame or image entity frequency, i.e., the pace at which the sequential image entities are gone through, may be set automatically for example optionally essentially to 10 image entities per second or to 8 image entities per second or to more image entities per second or to less image entities per second. According to an exemplary embodiment of the invention the framerate is set automatically according to the amount of selected image entities used in the video representation, such as that for example an increase in the amount of image entities used in the video representation increases the framerate or that increase in the amount of image entities used in the video representation decreases the framerate. Optionally the framerate may be set according to a user input.

According to an exemplary embodiment of the present invention the video representation may comprise audio, such as music, optionally in an even time signature such as 4/4 or 2/4. According to an exemplary embodiment of the present invention the audio used in the video representation may be chosen by the user. Optionally the audio may be chosen by the computing entity according to the image entities for example according to the amount of selected image entities and/or length of the video representation. According to an exemplary embodiment of the present invention the audio used in the video representation may be added before the video representation is produced and/or after the video representation is produced.

According to an exemplary embodiment of the present invention a graphical indication of an image entity preferably comprises at least one element selected from the group consisting of: the image entity itself, a miniaturized or scaled version of the image entity, an icon representing the image entity, a zoom-in extract of the image entity, a snapshot of the image entity, a text or a single letter representing the image entity, numeric representation of the image entity, and alphanumeric representation of the image entity. The representations may vary in size, form and (digital) format.

According to an exemplary embodiment of the present invention the image entities preferably comprise digital image files, such as picture, drawing, photograph, still image and/or other graphics files. The digital image files may be vector and/or raster images. According to an exemplary embodiment the image entities selectable or selected for the video representation consist of essentially single file format. According to an exemplary embodiment the image entities selectable or selected for the video representation comprise essentially a plurality of different file formats.

According to an exemplary embodiment of the present invention the image entities are preferably comprised in a system feature, such as a folder or a gallery.

According to an exemplary embodiment of the present invention the image entities are stored in the electronic device such as a terminal device, optionally mobile terminal device or ‘smartphone’, a tablet computer or a desktop computer. According to an exemplary embodiment of the present invention the image entities are stored in a remote cloud computing entity, such as a remote server, wherefrom they may be accessible and displayable via a plurality of different devices, such as mobile and desktop devices.

The image entities may be from and/or created by a number of different devices. According to an exemplary embodiment of the present invention a number of the image entities may be created by the electronic device itself either automatically or responsive to user input via a camera feature. According to an exemplary embodiment of the present invention a number of the image entities may have been created outside the electronic device and utilized by the device or retrieved on the device to be used by the device in terms of visualization, for instance. According to an exemplary embodiment of the present invention the image entities may comprise a combination of image entities produced by the electronic device and image entities acquired externally, optionally stored on a remote device or transferred to the electronic device from an external source.

According to an exemplary embodiment of the present invention the display configured by the computing entity to display graphical features may comprise essentially touch-based user interface, i.e. touch screen, or a substantially three-dimensional, and optionally at least partially contactless, user interface.

According to an exemplary embodiment of the present invention the continuous user input gesture may be engendered with means, such as one or more fingers, another similarly suitable anatomical part and/or by a stylus, for example.

According to an exemplary embodiment of the present invention the computing entity is configured to display graphical features such as user interface features (e.g. functional icons, menu structures and/or status data) or image data via the display screen and to capture user input via said graphical user interface. According an exemplary embodiment of the present invention the computing entity is preferably used to combine selected image entities to produce a video representation of said image entities, such as a time-lapse or other digital video file.

According to an exemplary embodiment of the present invention the video representation comprises or consists of two or more image entities. According to an exemplary embodiment of the present invention the video representation comprises a number of image entities and a number of video files. According to an exemplary embodiment of the present invention the video representation comprises only a number of video files.

According to an exemplary embodiment of the present invention selecting two or more image entities by the user input gesture preferably comprises engendering user input essentially continuously along a path substantially upon graphical indications of selectable user interface image entities, wherein the graphical indications of selectable user interface image entities substantially along, or underlying, the path are selected.

According to an exemplary embodiment of the present invention selecting two or more image entities by the user input gesture comprises engendering user input essentially continuously along a path substantially around graphical indications of selectable user interface image entities, wherein the graphical indications of selectable user interface image entities substantially inside the contour of the path or falling substantially within the path are selected. According to the latter practice, the one or more areas from which the image entities are selected from is defined by the contour of the curve according to user input gesture path and the end points of said curve.

According to an exemplary embodiment of the present invention the configuration to detect the selection of image entities made by the user input gesture via the graphical user interface is such that every indication of image entity along the path and so in the beginning and end of the path are chosen as part of the selection; i.e., selected. ‘Indication to remain along the path’ may require e.g. that the input gesture detected is at least momentarily provided to the area substantially above the rendered indication. According to an exemplary embodiment the image entities at least tangential to the path are chosen as part of the selection. ‘Tangential’ may refer to substantially neighboring locations such as coordinates or pixels, for example.

According to an exemplary embodiment of the present invention the configuration to detect the selection of image entities made by the user input gesture via the graphical user interface may, in particular, be set so as to detect the selection of a graphical indication of image entity along user input gesture path according to a threshold parameter value, such as for example at least essentially a percentage of the graphical indication of an image entity has to be split or covered by the user input gesture in order that the according image entities are detected as selected image entities. According to an exemplary embodiment of the present invention the computing entity may be configured to verify the selected image entities and optionally the image entities less below the user input path than the defined threshold parameter value.

According to an exemplary embodiment of the present invention the electronic device may be used together or included in for example a variety of electronic devices incorporating various user interfaces (UI) such as terminal devices including, inter alia, desktop, laptop, palmtop and/or tablet/pad devices.

In accordance with another aspect of the present invention a method for obtaining user input through an electronic device, comprising:
receiving essentially continuous user input gesture provided along a path substantially upon graphical indications of image entities rendered on a graphical user interface via a touchscreen,
detecting the indications underlying the path as a selection of corresponding image entities by the user,
combining and translating said selected image entities into a video representation of said image entities.

According to an exemplary embodiment of the present invention the input gesture may comprise essentially free movement in any direction essentially upon the graphical indications, such as moving horizontally, vertically and/or in any direction between predefined horizontal and vertical directions relative to provided GUI upon the graphical indications. Typically, when the user input gesture is provided via touch screen, the gesture is provided relative to a two-dimensional plane defined by the touch surface of the touch screen.

According to an exemplary embodiment of the present invention the user input gesture may preferably comprise changing (moving) direction during the gesture. Changing the user input gesture direction may comprise changing direction essentially gradually, such that the direction may be changed essentially freely during the movement of the gesture so that the gesture path produces curves, which have no discontinuity points other than the starting and end points, and/or the direction changes of the gesture may be done such that changing the movement direction of the gesture produces discontinuity points. However, the aforementioned interpretation for the changing of direction applies for the geometrical rendition of the path produced by the user input gesture, i.e., how the computing entity (captures) perceives (geometrically) the path of the gesture upon the graphical user interface entities, such as upon the graphical indications. According to an exemplary embodiment the user input gesture may comprise essentially only one (moving) direction.

Additionally or alternatively, the pace of the gesture may change from astatic state to a relatively rapid movement, and various different paces in between. Beginning or end of a gesture may be detected, for example, from a rapid introduction or loss of pressure, or generally input means, respectively on a touch-sensitive surface.

In accordance with one aspect of the present invention a computer program product embodied in a non-transitory computer readable medium, comprising computer code for causing the computer to execute:
receiving essentially continuous user input gesture provided along a path substantially upon graphical indications of image entities rendered on a graphical user interface via a touchscreen,
detecting the indications underlying the path as a selection of corresponding image entities by the user,
combining and translating said selected image entities into a continuous representation of said image entities.

The previously presented considerations concerning the various embodiments of the electronic device may be flexibly applied to the embodiments of the method mutatis mutandis and vice versa, as being appreciated by a skilled person. Similarly, the electronic structure obtained by the method and corresponding arrangement is scalable in the limitations of the entities according to the arrangement.

As briefly reviewed hereinbefore, the utility of the different aspects of the present invention arises from a plurality of issues depending on each particular embodiment.

The expression “a number of” may herein refer to any positive integer starting from one (1). The expression “a plurality of” may refer to any positive integer starting from two (2), respectively.

The expression “engender”, which is mainly used in context of giving user input, is herein used to refer to user action of giving input via any user interface, such as touch-based or three-dimensional user interface.

The term “exemplary” refers herein to an example or example-like feature, not the sole or only preferable option.

Different embodiments of the present invention are also disclosed in the attached dependent claims.

### BRIEF DESCRIPTION OF THE RELATED DRAWINGS

Next, the embodiments of the present invention are more closely reviewed with reference to the attached drawings, wherein

FIG. 1 is a block diagram of one embodiment of an electronic device in accordance with the present invention.

FIG. 2 is a flow diagram of one embodiment of a method for obtaining user input trough an electronic device in accordance with the present invention.

FIG. 3 illustrates an exemplary embodiment of the user input gesture for selecting a plurality of image entities in accordance with the present invention.

FIG. 4 illustrates an embodiment of translating a selection of image entities into an action producing a video representation of said image entities in accordance with the present invention.

### DETAILED DESCRIPTION OF THE EMBODIMENTS

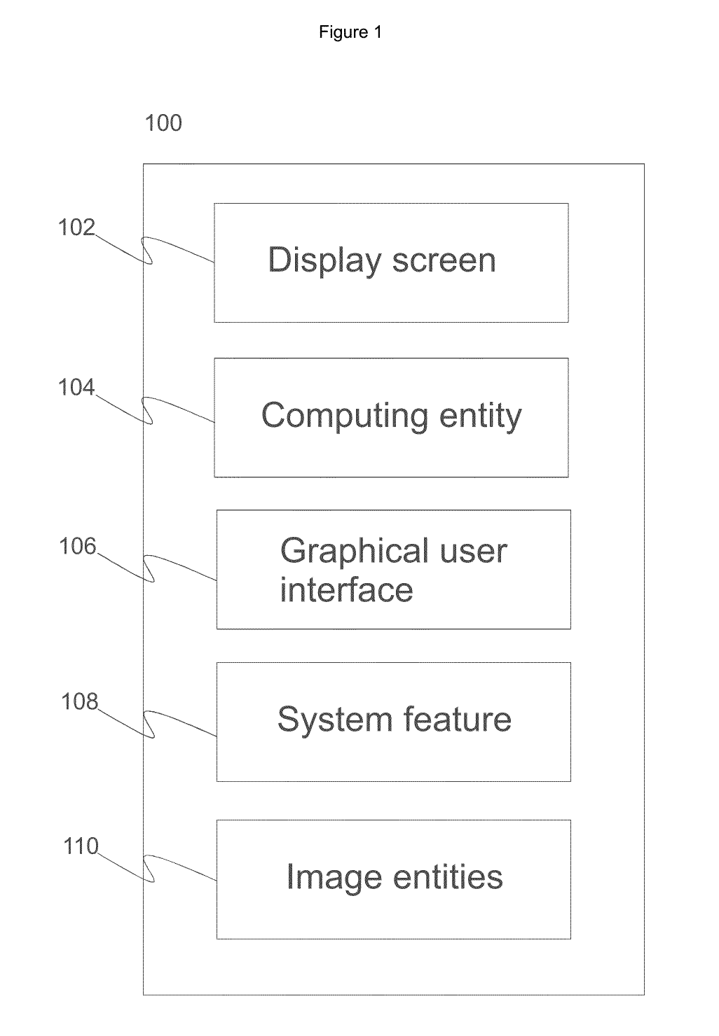

With reference to FIG. 1, a block diagram of one feasible embodiment of the electronic device 100 of the present invention is shown.

The electronic device 100 essentially comprises a display screen 102, a computing entity 104, a graphical user interface 106, a system feature 108 and image entities 110. Optionally and/or additionally at least part of the system feature 108 and/or the image entities 110 may be located external to the device 100 wherein the device 100 uses said system feature 108 and image entities 110 remotely.

The display screen 102 may comprise LCD (liquid crystal display), LED (light-emitting diode), organic light-emitting diode (OLED) or plasma display, for instance. So-called flat display technologies such as the aforementioned LCD, LED or OLED are in typical applications preferred but in principle other technologies such as CRT (cathode ray tube) are feasible in the context of the present invention as well.

Optionally the display screen 102 may comprise essentially touch-based user interface, i.e. touch screen, or a substantially three-dimensional, and optionally at least partially contactless, user interface. The touchscreen may comprise camera-based, capacitive, infrared, optical, resistive, strain gauge and surface acoustic wave user interface technology. The touchscreen is preferably capable of detecting input such as static touches and/or continuous movement essentially upon and/or on a surface. Optionally the touchscreen may be capable of detecting three-dimensional input such as movement inside a predetermined space optionally above and/or in reference to the touchscreen. Optionally the touchscreen may be capable of detecting user input essentially on and/or upon a surface, such as touch-based user input, and over a surface, such as three-dimensional user input.

The computing entity 104 preferably detects user input via the graphical user interface 106 by processing data from various sources such as sensors and memory. The computing entity 104 comprises, e.g. at least one processing/controlling unit such as a microprocessor, a digital signal processor (DSP), a digital signal controller (DSC), a micro-controller or programmable logic chip(s), optionally comprising a plurality of co-operating or parallel (sub-)units.

The computing entity 104 is further on connected or integrated with a memory entity, which may be divided between one or more physical memory chips and/or cards. The memory entity may comprise necessary code, e.g. in a form of a computer program/application, for enabling the control and operation of the device 100, and provision of the related control data. The memory may comprise e.g. ROM (read only memory) or RAM-type (random access memory) implementations as disk storage or flash storage. The memory may further comprise an advantageously detachable memory card/stick, a floppy disc, an optical disc, such as a CDROM, or a fixed/removable hard drive.

The graphical user interface entity 106 may be configured to visualize different data elements, status information, control features, user instructions, user input indicators, etc. to the user via the display screen 102 as controlled by the computing entity 104.

The system feature, or ‘resource’, 108 is preferably used as a location to store image entities 110. The system feature 108 may comprise a folder or a gallery feature, for example. The system feature 108 may further on comprise, control or input data to an application and/or a feature of the graphical user interface 106.

Accordingly, the computing entity 104 may arrange the graphical indications of image entities 110 as a grid or other type of symmetrical, asymmetrical or any other visual geometrically arranged representation. The representation is preferably scrollable, pannable (i.e., able to be panned) and/or scalable preferably during the user input gesture, optionally such as to make the indications of image entities 110 more easily selectable. Further on, the grid or other representation may be arranged to scale such that for example the grid or geometrical arrangement of the indications of image entities 110 changes size and/or shape as the shape or size of e.g. surrounding window or other encompassing graphical element is adjusted by the user or the entity 104 itself.

The system feature 108 may be at least essentially partly comprised in the electronic device 100 or it may be external to the device 100 remotely accessible via, and optionally usable on, the device 100. Optionally the system feature 108 is comprised in the device 100. Optionally the system feature 108 may be facilitated via and by the device 100 as a software as a service (SaaS) wherein the device 100 uses the system feature 108 via the graphical user interface 106 although the system feature 108 is located external to the device 100. Optionally the system feature 108 may be facilitated via a browser or similar software wherein the system feature 108 is external to the device 100 but remotely accessible and usable together with the graphical user interface 106. The system feature 108 may include and/or be comprised in a cloud server or a remote terminal or server.

The image entities 110 are represented visually on the graphical user interface 106 by graphical indications.

Optionally the graphical indications may also comprise visual representations of video entities and/or audio entities.

The graphical indications preferably comprise at least one element selected from the group consisting of: essentially an image entity 110 itself, a miniaturized or scaled version of an image entity 110, an icon, a zoom-in extract of an image entity 110, a snapshot of an image entity 110, a text or a single letter representing an image entity 110, numeric representation of an image entity 110, and alphanumeric representation of an image entity 110. The representations may vary in size, form and (digital) format.

The image entities 110 preferably comprise digital image files, such as picture, drawing, photograph, still image and/or other graphics files. The digital image files may be vector and/or raster images.

The image entities 110 may be stored in the electronic device 100. However, the image entities 110 may be stored also in a remote cloud computing entity, such as a remote server, as already mentioned hereinbefore, wherefrom they may be accessible and displayable via the electronic device 100 and/or a plurality of different devices, such as mobile and desktop devices.

The image entities 110 may be originally from and/or created by a number of different devices. The image entities 110 may be created by the electronic device 100 itself either automatically or responsive to user input via a camera, image creating and/or image editing/processing feature. A number of the image entities 110 may have been created outside the electronic device 100 and utilized by the device 100 or retrieved on the device 100 to be used by the device 100 in terms of visualization, for instance. The image entities 110 may also comprise a combination of image entities 110 produced by the electronic device 100 and image entities 110 acquired externally, optionally stored on a remote device or transferred to the electronic device 100 from an external source.

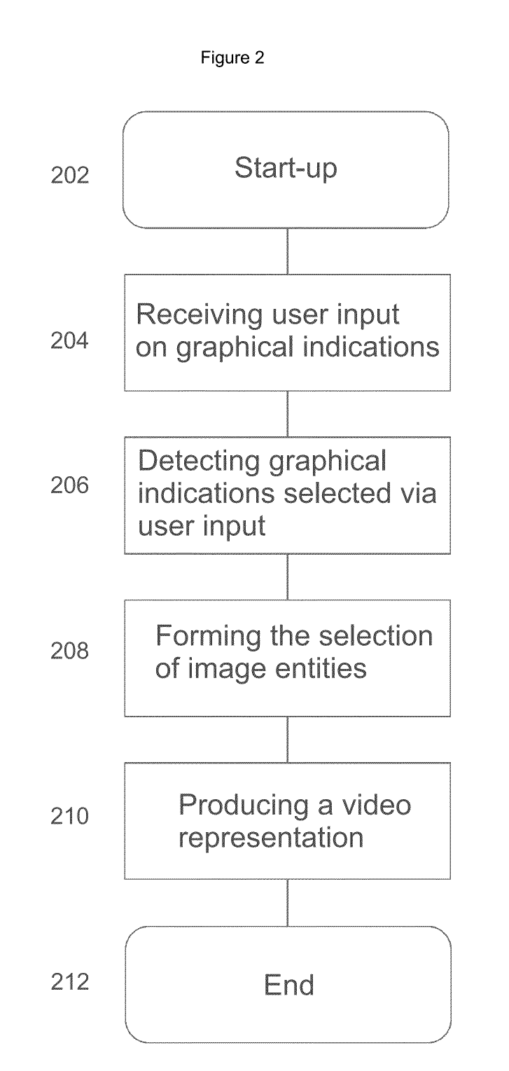

With reference to FIG. 2, a flow diagram of one embodiment of a method for obtaining user input through an electronic device in accordance with the present invention is shown.

At 202, referred to as the start-up phase, the device executing the method is at its initial state. At this initial phase the computing entity is ready to detect and act on user input via the graphical user interface. This phase may also include activating and configuring the device and related features used for visualizing and obtaining the image entities.

At 204, the user input gesture is engendered essentially upon the graphical user interface. The user input gesture may comprise essentially free movement in any direction essentially upon the graphical indications, such as moving horizontally, vertically and/or in any direction between horizontal and vertical directions upon the graphical indications. Typically, when the user input gesture is provided via touch screen, the gesture is provided relative to a two-dimensional plane defined by the touch surface the touch screen. In case of three-dimensional input, it may be translated into two-dimensional input prior to or upon determining the path determined by the user.

The user may also change the direction of the gesture during the engendering of the gesture. Changing the gesture direction may comprise changing direction essentially gradually, such that the direction may be changed essentially freely during the movement of the gesture so that the gesture path produces curves, which have no discontinuity points other than the starting and end points, and/or the direction changes of the gesture may be done such that changing the movement direction of the gesture produces discontinuity points. However, the aforementioned interpretation for the changing of direction applies for the geometrical rendition of the path produced by the user input gesture, i.e., how the computing entity (captures) perceives (geometrically) the path of the gesture on the graphical user interface entities, such as upon the graphical indications. Optionally, the user input gesture may comprise essentially only one (moving) direction.

At 206, the image entities selected according to the graphical indications selected by the user input gesture are detected.

At 208, the device confirms from the user that the image entity selection is finished and ready to be used for the video representation. The user may be given at this phase an option to add or remove image entities. The adding or removing of image entities may be done by using the user input gesture or by pointing out image entities, optionally on the same view as whereon the initial selection of image entities was made and/or on a different view than that used for the initial selection of image entities.

The confirmation may take place after the user input gesture has stopped, after the user input gesture has remained substantially static for a period of time, and/or after the user input gesture engender via the graphical user interface has stopped, such as when the user input gesture is no longer detected via the graphical user interface.

The confirmation may present the selection of image entities to the user visually by for example tagging, highlighting, outlining, coloring, and/or otherwise marking the graphical indications according to the image entities. Optionally either of the inquiries may be essentially textual, such as a question posed via the graphical user interface to the user. Optionally the inquiry may be done on another view and/or system feature than the one that is present during the first selection of graphical indications of the image entities.

The user may be presented with a preview of the video representation according to the image entity selection.

At 210, the video representation is produced according to the image entity selection. The user may be inquired a confirmation that a video representation is made. Optionally the computing entity may be configured to commence the process of translating selected image entities into an action producing a video representation of said image entities substantially automatically optionally directly after the computing entity has detected a selection of image entities.

The user may be also inquired of whether audio is added to the video and/or what kind of audio is used. Optionally the audio may be added to the video automatically.

At 212, referred to as the end phase of the method, the user may be presented with the video representation and/or the video representation may be transferred or saved to a location, optionally according to user input.

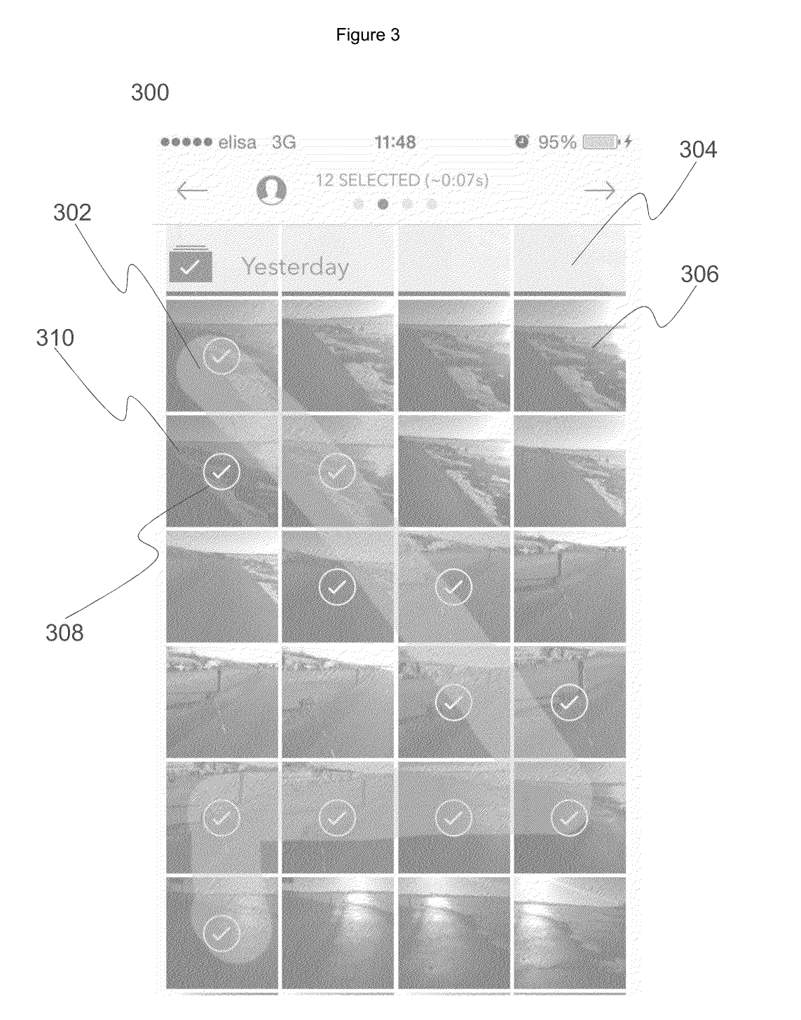

With reference to FIG. 3, an exemplary embodiment of a user input path 302 according to user input gesture is illustrated.

The user input path 302 is herein either in process or completed using the system feature 304 together or in the graphical user interface 300. The user has herein selected the graphical indications of image entities 310 marked as selected herein as an example with the symbol 308. As is depicted, the user input gesture has herein formed a path 302 which marks the graphical indications essentially along the path 302 as selected 310. The image entities 306 not at all and/or not essentially on the path 302 according to the user input gesture are not selected as is herein depicted by the absence of a symbol 308.

Continuous user input gestures may be engendered with means, such as one or more fingers, another similarly suitable anatomical part and/or by a stylus, for example. Further on, the input means depends also on the user interface technology.

Continuous user input gesture may be also given to the electronic device by an input device, such as a mouse and/or a joystick, which is particularly preferable in embodiments where the electronic device doesn't comprise and/or utilize touchscreen, but e.g. an ordinary display instead.

The path 302 essentially defined by the user input gesture may be graphically and/or textually visualized during the engendering of the user input gesture and/or essentially after a user input gesture has been engendered. The graphical and/or textual visualization may comprise tagging, highlighting, outlining, coloring, text or a number of letters along the path 302, and/or on the graphical indications, and/or other marking of the path 302. In the example of FIG. 3, the path 302 is depicted as having an essentially translucent coloring according to the geometrical shape of user input means.

The image entities are detected as selected 310 if their according graphical indications are essentially along the path 302, in the starting and/or ending point of the path 302, and/or tangential to the path 302 created by the user input gesture.

Optionally the image entities are detected as selected according to the geometrical dimensions of the input gesture means, essentially such that for example at least essentially a percentage of the graphical indication of an image entity has to be covered by the user input gesture in order that the according image entities are detected as selected image entities 310.

The computing entity may be configured to verify the selected image entities 310 from the user. Herein the user may be able to engender input gesture for selecting new image entities into the image entity selection translated to video representation and/or the user may be able to engender user input gesture for deselecting, i.e., removing, image entities from the selected image entities 310. Selecting and/or deselecting may be done by using a view, such as a list view or a folder view comprising selected image entities 310, created by the computing entity and/or the selection and/or deselection may be done by using the same view as when selecting the first selection of image entities.

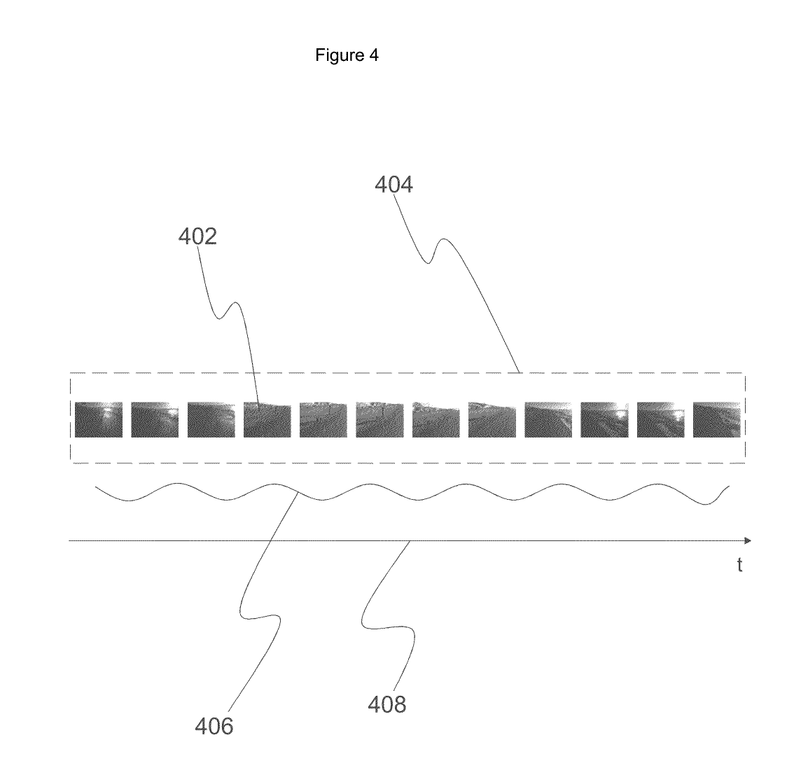

With reference to FIG. 4, a video representation 404 according to the image entities 402 preferably selected in accordance with the methodology indicated in FIG. 3 is depicted.

The video representation 404 comprises preferably two or more image entities 402 (the only one pointed out as an example of one of the many image entities) arranged essentially sequentially chronologically (as illustrated with the time axle 408), for example according to time code, time stamp and/or other time data, optionally comprised in or associated with the image entities 402 as metadata. Optionally the image entities 402 may be arranged essentially sequentially according to a parameter other than the time data, such as according to location data.

The video representation 404 may comprise only image entities 402 or a combination of image entities and video entities, such as digital video files. Optionally the video representation 404 may comprise only video entities. The video representation 404 may comprise a time-lapse or other digital video.

The video representation 404 may comprise, in addition to sequential user-selected (path belonging) image entities 402 and/or video entities, other image entities such as blank, different colored images and/or predetermined images in between, before and/or after said image entities 402 and/or video entities. Said other image entities may be chosen by the user/or they may be added to the video representation 404 automatically according to predefined logic.

The framerate of the video representation 404 may be set optionally automatically, for example, optionally essentially to 10 image entities per second or to 8 image entities per second or to more image entities per second or to less image entities 402 per second. Optionally, the framerate may be set automatically according to the number of selected image entities 402 and/or video entities used in the video representation, such as that for example an increase in the amount of image entities 402 used in the video representation 404 increases the framerate or that increase in the amount of image entities 402 used in the video representation decreases the framerate. Optionally, the framerate may be set according to a user input.

The video representation as well as the optional other video entities is preferably in a digital format, the format being optionally chosen by the user.

Optionally the video representation may comprise a combination of image entities 402, video entities, and/or audio entities 406, such as a number of digital music files or e.g. audio samples constituting optionally multichannel audio track. The audio entity 406 is preferably music in an even time signature such as 4/4 or 2/4. Alternatively or additionally, the audio track may include ambient sounds or noises. The audio entity 406 comprised in the video representation may be chosen by the user or the audio entity 406 may be optionally chosen by the computing entity for example according to the amount of selected image entities 402 and/or length of the video representation 404, and/or according to a predetermined choices of audio entities 406, such as from a list of audio files, optionally as a “playlist”. The audio entity 406 comprised in the video representation 404 may be added before the video representation 404 is produced and/or after the video representation 404 is produced.

The scope of the invention is determined by the attached claims together with the equivalents thereof. The skilled persons will again appreciate the fact that the disclosed embodiments were constructed for illustrative purposes only, and the innovative fulcrum reviewed herein will cover further embodiments, embodiment combinations, variations and equivalents that better suit each particular use case of the invention.

1. An electronic device comprising:
a display screen,
a computing entity configured to display graphical user interface via the display screen, and configured to capture user input via said graphical user interface, the computing entity further being configured to:
present a plurality of graphical indications of selectable image entities via the graphical user interface;
detect an essentially continuous user input gesture via said graphical user interface along a path substantially upon two or more of said indications as a selection of such indications and corresponding two or more image entities;
translate the selected image entities into an action producing a video representation of said image entities.

2. The device according to claim 1, wherein the graphical indication of an image entity may comprise the image entity itself, a miniaturized version of image entity, an icon of image entity, a zoom-in extract of image entity, a snapshot of image entity, a text or a single letter representing image entity, and/or another representation of image entity.

3. The device according to claim 1, wherein the selection of image entities according to a user input gesture may be edited, such as by selecting and/or deselecting a number of selected image entities.

4. The device according to claim 1, wherein the image entities are preferably digital image files, such as vector or raster format picture, photograph, still image and/or other graphics files.

5. The device according to claim 1, wherein the video representation of said image entities is digital video file.

6. The device according to claim 1, wherein the video representation of said image entities is a time-lapse.

7. The device according to claim 1, comprising a mobile terminal, optionally smartphone.

8. The device according to claim 1, comprising a desktop or a laptop computer.

9. The device according to claim 1, comprising a tablet or phablet computer.

10. A method for obtaining user input through an electronic device, comprising:
receiving essentially continuous user input gesture provided along a path substantially upon graphical indications of image entities rendered on a graphical user interface via a touchscreen,
detecting the indications underlying the path as a selection of corresponding image entities by the user,
combining and translating said selected image entities into a continuous representation of said image entities.

11. The method according to claim 10, wherein the user input gesture may comprise free movement in any direction, such as moving over, around and/or on the image entities diagonally, horizontally, vertically, and/or in direction between them.

12. The method according to claim 10, wherein the user input gesture may change movement direction during said user input gesture.

13. A computer program product embodied in a non-transitory computer readable medium, comprising computer code for causing the computer to execute:
receiving essentially continuous user input gesture provided along a path substantially upon graphical indications of image entities rendered on a graphical user interface via a touchscreen,
detecting the indications underlying the path as a selection of corresponding image entities by the user,
combining and translating said selected image entities into a continuous representation of said image entities.
